(19) United States
(12) Patent Application Publication
(10) Pub. No.: US 2016/0109791 A1
(43) Pub. Date: Apr. 21, 2016

(54) Inflatable Display

(71) Applicant: Occasions Ltd, Kowloon (HK)

(72) Inventor: Alan Siu Lun Chan, Kowloon (HK)

(73) Assignee: Occasions Ltd.

(21) Appl. No.: 14/876,676

(22) Filed: Oct. 6, 2015

Related U.S. Application Data
(60) Provisional application No. 62/066,711, filed on Oct. 21, 2014.

(51) Int. Cl. G03B 21/585; G03B 21/62; G03B 21/10

(52) U.S. Cl. CPC G03B 21/585; G03B 21/10; G03B 21/62

(57) ABSTRACT

An inflatable display is disclosed. The inflatable display contains an inflatable outer shell, wherein at least a portion of the inflatable outer shell is a display surface, at least one fan providing a continuous air flow to inflate the inflatable outer shell, a projection system within the inflatable outer shell and configured to display one or more images and/or video on the display surface.

### CROSS REFERENCE TO RELATED APPLICATIONS

This application claims the benefit of U.S. Provisional Application No. 62/066,711, filed on Oct. 21, 2014, which is incorporated herein by reference in its entirety.

### FIELD

The present invention relates to air-filed displays.

### BACKGROUND

Inflatable displays have a wide range of application, shape and size, including, but not limited to, figures for holiday and seasonal decoration, marketing, advertising, entertainment, and event attraction. The inflatable displays are made from a permeable fabric that allows air to pass through the fabric at approximately the same rate as the air being blown into the inflatable display. The process of continuously blowing air being supplied from a fan or other inflation device occurring at substantially the same rate as air escaping the fabric allows the display to maintain a three-dimensional shape without the use of an internal or external frame or structure. These are known in the industry as “cold-air” inflatable displays.

Typically, the cold-air inflatable display is a static figure formed from an inflation module which represents an individual figure when inflated. For example, a consumer may decide to decorate their house with a spider inflatable display for the Halloween season or a Santa Clause inflatable display for the holiday season. One of the limitations of the cold-air inflatable display is that they are static.

Presently disclosed embodiments overcome the limitations of the prior art.

### BRIEF DESCRIPTION OF THE FIGURES

FIGS. 1-2 depict an embodiment according to the present disclosure.

FIG. 3 depicts another embodiment according to the present disclosure.

FIG. 4 depicts a projection system according to some embodiments presently disclosed.

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

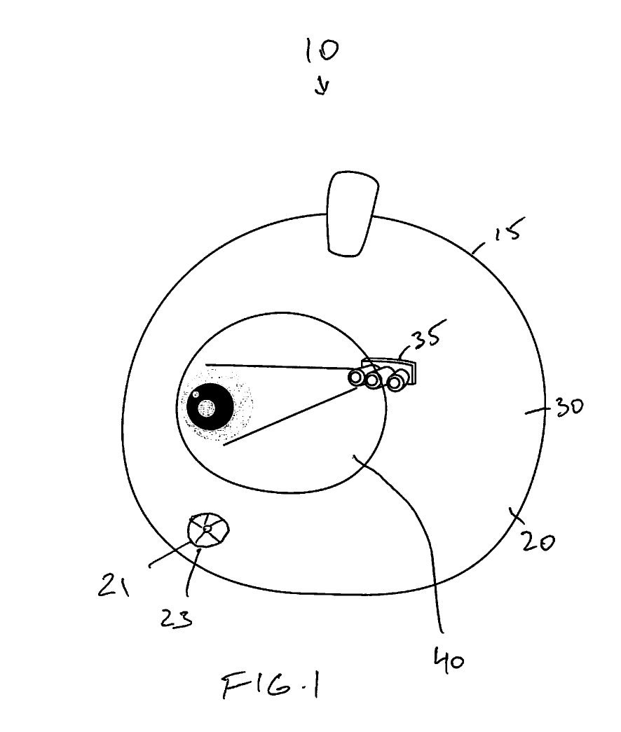

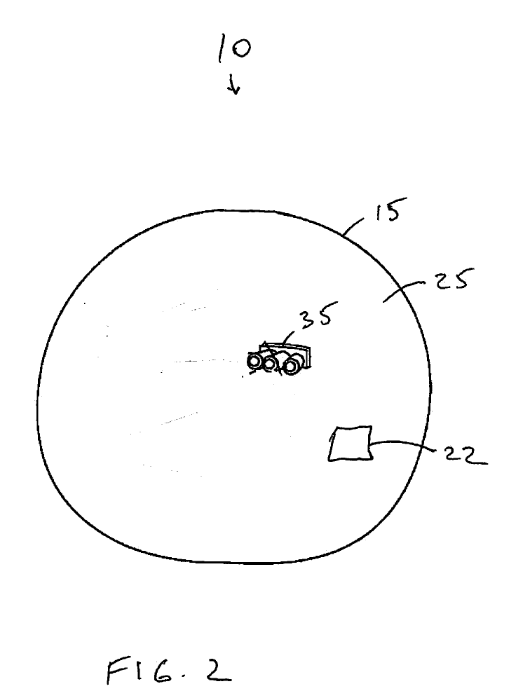

According to some embodiments, an inflatable display assembly 10 is shown in FIG. 1 and is presently disclosed. According to some embodiments, the inflatable display assembly 10 comprises an inflatable display 15. According to some embodiments, the inflatable display 15 comprises an inflatable outer shell 20. The inflatable outer shell comprises an interior surface 25 (shown in FIG. 2) and an outer surface 30 (shown in FIG. 1). FIG. 2 is a cutaway view of the inflatable display 15.

According to some embodiments, the inflatable display 15 comprises at least one fan 21 configured to inflate the inflatable outer shell 20. According to some embodiments, the at least one fan 21 comprises a motor/air pump 22 (shown in FIG. 2) and a grid 23 (shown in FIG. 1). According to some embodiments, the motor/air pump 22 is configured to pump outside air through the grid 23 to inflate the inflatable outer shell 20.

According to some embodiments, the inflatable outer shell 20 comprises a permeable fabric that allows air to escape at about the same rate as the air being blown into the inflatable outer shell 20 by the at least one fan 21.

According to some embodiments, the motor/air pump 22 is coupled with the interior surface 25. According to some embodiments, the at least one fan 21 implemented as a lightweight plastic sleeveless bearing fan. According to some embodiments, the at least one fan 21 is removable and can be easily removed from its housing for cleaning or replacement whenever necessary.

According to some embodiments, the inflatable display assembly 10 comprises a projection system 35 disposed within the inflatable display 15. According to some embodiments, the projection system 35 is coupled with the interior surface 25. According to some embodiments, the inflatable display 15 comprises a display surface 40. According to some embodiments, the projection system 35 is configured display one or more images and/or video on the display surface 40. According to some embodiments, the display surface comprises material that allows the one or more images and/or video from the projection system 35 to be viewed by anyone adjacent to the outer surface 30 of the inflatable display 15. According to some embodiments, the display surface 40 comprises same material as the inflatable display 15. According to some embodiments, the display surface 40 comprises transparent material.

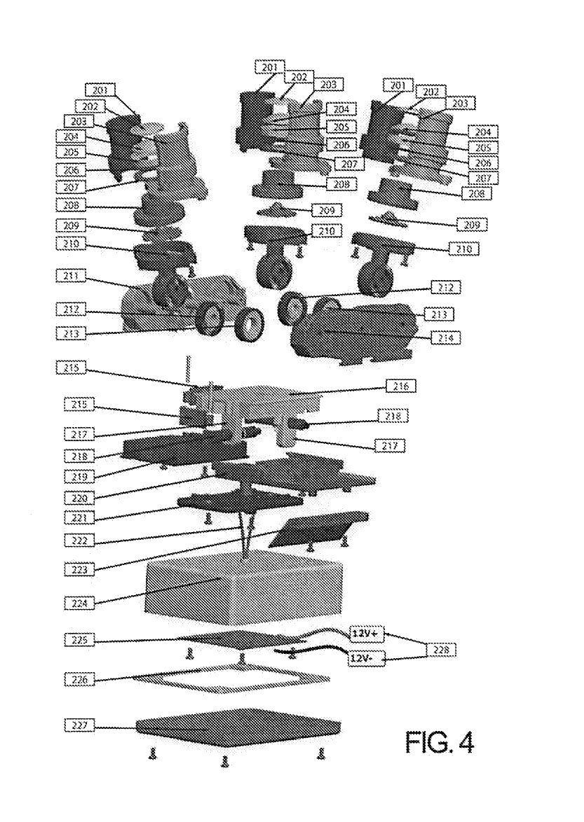

Referring to FIG. 4, according to some embodiments the projection system 35 comprises one or more upper LED holders 201, one or more first lens 202, one or more lower LED holders 203, one or more lens 204, one or more front film holder 205, one or more films 206, one or more rear film holders 207, one or more heat insulation covers 208, one or more LEDs 209, one or more back cover LED holders 210, upper main housing 211, top gear 212, bottom gear 213, lower main housing 214, locking plate 215, front sliding box 216, plate 217, screw pin 218, rear sliding box 219, sliding plate 220, locking plate 221, one or more wires 222, platform 223, a power source (not shown), a Printed Circuit Board Assembly (PCBA) box 224, Printed Circuit Board Assembly (PCBA) with electronic parts 225, an O-ring 226, and a Printed Circuit Board Assembly (PCBA) box cover 227.

According to some embodiments, after plugging into the power source (not shown), the LEDs 209 light up and the projection system 35 creates an image by shining a light through a film 206 and lens 202, 204. According to some embodiments, the PCBA (printed circuit board assembly) 225 controls which LEDs are turned on in the projection system 35 so that the projected images can be in sequence. According to some embodiments, the angle of projection images can be adjusted by turning part 210, 212, 213. According to some embodiments, the sliding box 215-220 on the back of LED holder allows fine tuning of the position of projected image if the projected image is not in the proper position.

According to some embodiments, the inflatable display assembly 10 comprises a motion detector (not shown) associated with the projection system 35. According to some embodiments, the motion detector (not shown) is configured to activate the projection system 35 when motion is detected. According to some embodiments, the motion detector (not shown) is configured to have the projection system 35 display one or more images and/or video on the display surface 40 when motion is detected and to have the projection system 35 stop displaying one or more images and/or video on the display surface 40 when the motion stops. According to some embodiments, the motion detector (not shown) is configured to have the projection system 35 stop displaying one or more images and/or video on the display surface 40 when motion is detected and to have the projection system 35 display one or more images and/or video on the display surface 40 when the motion stops.

According to some embodiments, the inflatable display assembly 10 comprises a speaker (not shown) to play audio. According to some embodiments, the inflatable display assembly 10 comprises a processor (not shown) and a memory (not shown). According to some embodiments, the speaker (not shown) is configured to play one or more audio files stored in the memory (not shown). According to some embodiments, the speaker (not shown) is configured to play one or more audio files when the projection system 35 projects one or more images and/or video(s). According to some embodiments, the speaker (not shown) is configured to play one or more audio files received through a radio frequency (RF) circuitry (not shown and described in more detail below).

According to some embodiments, the inflatable display assembly 10 comprises a radio frequency (RF) circuitry (not shown). The RF circuitry (not shown) may be configured to receive and transmit RF signals, also called electromagnetic signals. The RF circuitry (not shown) converts electrical signals to/from electromagnetic signals and communicates with communications networks and other communications devices via the electromagnetic signals. The RF circuitry (not shown) may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry (not shown) may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

According to some embodiments, the RF circuitry (not shown) is configured to allow a user to activate the projection system 35 from a remote location. According to some embodiments, the RF circuitry (not shown) is configured to have the projection system 35 display one or more images and/or video on the display surface 40 when receiving a first signal from the user and to have the projection system 35 stop displaying one or more images and/or video on the display screen 40 when receiving a second signal from the user.

According to some embodiments, the inflatable display assembly 10 comprises a memory (not shown). The memory (not shown) may comprise high-speed random access memory and/or non-volatile memory, such as one or more magnetic disk storage devices, flash memory devices, or other non-volatile solid-state memory devices. According to some embodiments, the one or more images and/or vide projected by the projection system 35 are stored in the memory (not shown). According to some embodiments, the one or more images and/or vide projected by the projection system 35 are downloaded into the memory (not shown) from a remote server and/or storage through the RF circuitry (not shown).

Although the inflatable display 15 is represented as a pumpkin, it is to be understood that the inflatable display 15 can be any shape and/or size and is not limited to being only a pumpkin. According to some embodiments, the inflatable display 15 is shaped as a human being, animal, insect, fictional character, geometric shape, building, structure or any other shape.

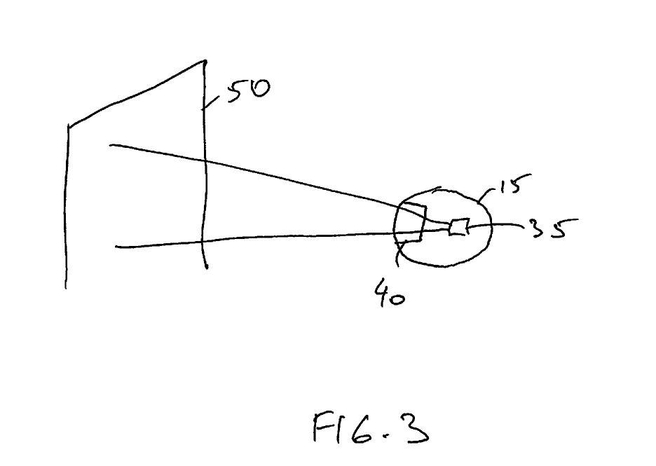

According to some embodiments, the one or more images and/or video projected by the projection system 35 is projected through the display surface 40 on to an object 50 as shown in FIG. 3. According to some embodiments, the object 50 is a wall, fence, movie screen, etc.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . . ”

What is claimed is:

1. An inflatable display comprising:
an inflatable outer shell, wherein at least a portion of the inflatable outer shell is a display surface;
at least one fan providing a continuous air flow to inflate the inflatable outer shell;
a projection system within the inflatable outer shell and configured to display one or more images and/or video on the display surface.

2. The inflatable display of claim 1, wherein the display surface comprises same material as the inflatable outer shell.

3. The inflatable display of claim 1, wherein the display surface comprises first material and the inflatable outer shell comprises second material.

4. The inflatable display of claim 1, wherein the display surface comprises transparent material.

5. The inflatable display of claim 1, wherein the display surface comprises material that allows the one or more images and/or video from the projection system to be viewed by anyone adjacent to the inflatable outer shell.

6. An inflatable display comprising:
an inflatable outer shell, wherein at least a portion of the inflatable outer shell is a display surface;
at least one fan providing a continuous air flow to inflate the inflatable outer shell;
a projection system within the inflatable outer shell and configured to display one or more images and/or video through the display surface and on an object located at first distance from the inflatable outer shell.

7. The inflatable display of claim 6, wherein the display surface comprises transparent material.

8. The inflatable display of claim 6, wherein the object is a wall, fence or movie screen.
